(19) United States
(12) Patent Application Publication
(10) Pub. No.: US 2013/0247784 A1
(43) Pub. Date: Sep. 26, 2013

(54) CAN DECORATOR ASSEMBLY WITH DUAL CAM MANDREL GUIDANCE

(71) Applicant: James M. Jeter, Jacksonville, FL (US)

(72) Inventor: James M. Jeter, Jacksonville, FL (US)

(21) Appl. No.: 13/850,929

(22) Filed: Mar. 26, 2013

Related U.S. Application Data
(60) Provisional application No. 61/615,565, filed on Mar. 26, 2012.

(51) Int. Cl. B41F 17/28

(52) U.S. Cl. CPC B41F 17/28
USPC 101/35

(57) ABSTRACT

An improved cam mandrel guidance system for use with decorating machines or other equipment utilizing multiple mandrels mounted on a rotating drum or disk plate. The mandrels being adapted to temporarily receive and retain work pieces, such as blank cans.

### CROSS REFERENCE TO RELATED APPLICATION

This application claims the benefit of U.S. Provisional Patent Application No. 61/615,565, filed Mar. 26, 2012. The patent application identified above is incorporated herein by reference in its entirety to provide continuity of disclosure.

### BACKGROUND OF THE INVENTION

The invention relates generally to the field of equipment that incorporates multiple mandrels for temporarily receiving work pieces upon which a process must be performed; where it is sometimes necessary to quickly retract or reposition a mandrel. More particularly, the invention relates to such equipment wherein the mandrel needs to be retracted in a direction perpendicular to the longitudinal axis of the mandrel.

A mandrel is typically a cylindrical member used to retain another object during a processing operation. For example, in typical equipment used in the printing of beverage cans, a large number of freely rotating mandrels are mounted about the perimeter of a large rotating drum or disk plate, the longitudinal axes of the mandrels being parallel to the axis of the rotating drum. A blank can is placed onto each mandrel at a loading station, and the drum then rotates the loaded mandrel past an applicator or printing mechanism, such as a rotating wheel having a series of inked printing blankets. The can loaded onto the mandrel contacts the printing blanket and ink is transferred in a precise manner. After inking, a varnish or lacquer is often applied as a sealant in the same manner. This type of equipment, often referred to as can decorators, is designed to handle large quantities of cans in a very short time. For example, a typical decorating machine of the type described having from 24 to 36 equally spaced mandrels may produce over 2000 printings per minute.

The mandrels are mounted onto a single disk plate or a pair of disk plates mounted onto a rotating shaft. As the mandrels rotate, they must be extended and retracted in the radial direction multiple times during a single rotation. To accomplish this, a stationary, substantially annular cam is used to guide movement of the mandrel in the radial direction, the mandrel support assembly being provided with a cam follower.

The mandrels are mounted to the mandrel support assemblies such that one end is free so the cans may be loaded and removed. When the mandrels are pressed against the printing blankets, a significant force is transferred to the mandrel in the radial direction. Because only one end of the mandrel is supported, the force and stress is not evenly distributed along the mandrel.

It is an object of this invention to address this problem by providing a dual cam guide wherein the mandrel mounting assembly has a rear cam follower and a front cam follower to provide front and rear support to the mandrel mounting assembly.

### SUMMARY OF THE INVENTION

The invention is an improved cam mandrel guidance system for use with decorating machines or other equipment utilizing multiple mandrels mounted onto a rotating drum or disk plate, the mandrels being adapted to temporarily receive and retain work pieces, such as a blank can to be imprinted for example, where extension and retraction of each mandrel in the radial direction relative to the axis of the drum or disk plate is required multiple times during a single revolution of the drum. The invention is such an apparatus wherein each mandrel has a mandrel support assembly mounted onto or adjacent the circumference of a rotating drum or like member for properly positioning the mandrel for desired operations, such as printing or coating of a can mounted onto the mandrel for example, the mandrel support assembly able to be extended or retracted in the radial direction (relative to the rotational axis of the drum) as required. Each mandrel support assembly is provided with a pair of cam followers, one on the front and one on the rear, relative to the axial direction. A pair of coordinated, stationary cams are provided, one on the front side of the mandrel support assembly and the other to the rear of the mandrel support assembly, wherein the cam followers are received by their respective cams. The cams define a guide or pathway controlling the movement of the mandrel support assemblies in the radial direction as the mandrel support assemblies are rotated, and provide support to the front and rear of the mandrel support assemblies to better distribute forces and stresses encountered during the decorating operation.

### BRIEF DESCRIPTION OF THE DRAWINGS

FIG. 1 is a side view showing an embodiment of the dual cam mandrel guidance system.

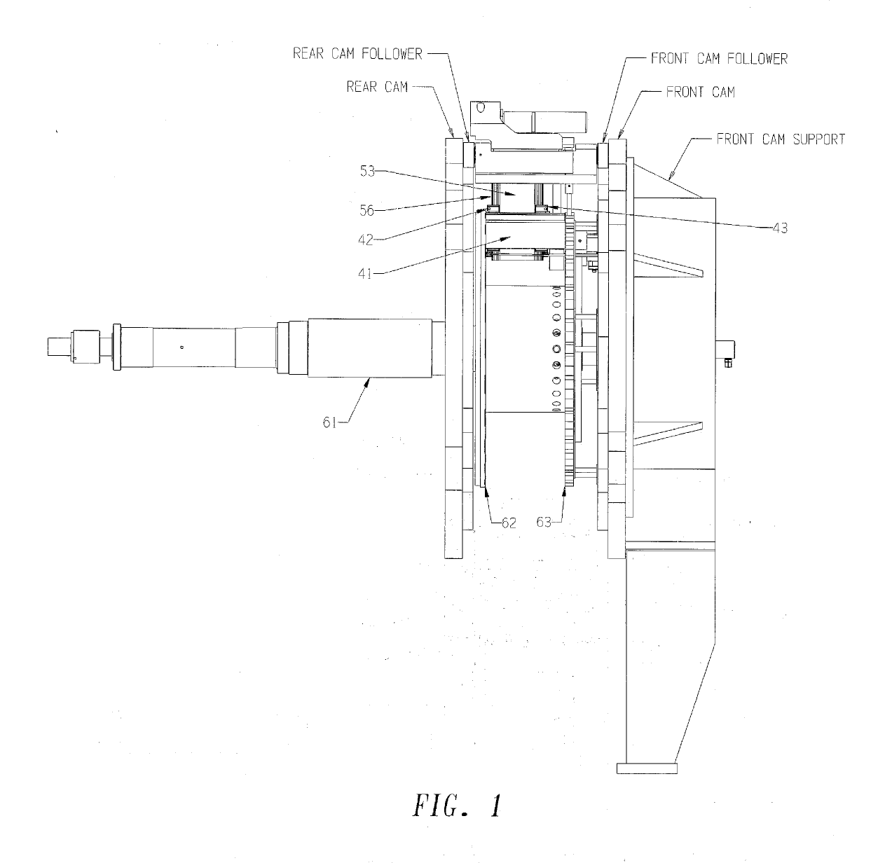

FIG. 2 is a perspective view of the embodiment of FIG. 1.

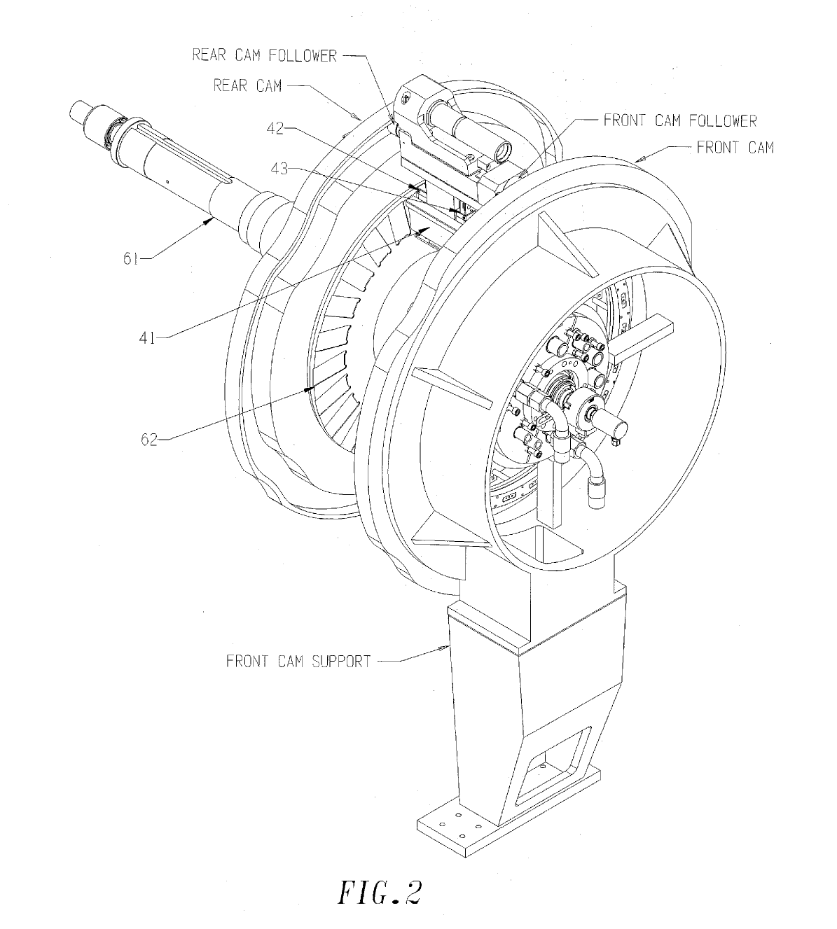

### DETAILED DESCRIPTION OF THE INVENTION

The invention is an improved earn mandrel guidance system for use with decorating machines or other equipment utilizing multiple mandrels mounted onto a rotating drum or disk plate, the mandrels being adapted to temporarily receive and retain work pieces, such as a blank can to be imprinted for example, where extension and retraction of each mandrel in the radial direction relative to the rotational axis of the drum or disk plate is required multiple times during a single revolution of the drum. The invention is such an apparatus wherein each mandrel has a mandrel support assembly mounted onto or adjacent the circumference of a rotating drum or like member for properly positioning the mandrel for desired operations, such as printing or coating of a can mounted onto the mandrel for example, the mandrel support assembly able to be extended or retracted in the radial direction, relative to the rotational axis of the drum, as required. Each mandrel support assembly is provided with a pair of cam followers, one on the front and one on the rear relative to the axial direction. A pair of coordinated, stationary cams are provided, one on the front side of the mandrel support assembly and the other to the rear of the mandrel support assembly, wherein the cam followers are received by their respective cams. The cams define a guide or pathway controlling the movement of the mandrel support assemblies in the radial direction as the mandrel support assemblies are rotated, while simultaneously supporting the mandrel support assemblies in the front and rear to better distribute forces and stresses encountered during the decorating operation.

The dual cam mandrel guidance system may be utilized with decorator assemblies having a single rotating drum or disk plate onto which the mandrels are mounted, a typical structure in known decorators, or with a decorator assembly having a pair of drums or disks, one to the front and one to the rear of the mandrel support assemblies, the paired drums or disks providing front and rear support to the mandrel trip assemblies utilized to retract a mandrel when a no-load or mis-load circumstance occurs. Such a system is set forth in my pending U.S. patent application Ser. No. 13/426,211 and the mandrel trip system of that application is used in the illustrations herein.

In this type of decorator assembly, the rail guide mounting assembly comprises a base mount assembly in combination with a rail support assembly, the base mount assembly comprising a brace member 41 mounted to a rotating plate member, and most preferably mounted to and between a front plate member 63 and a rear plate member 62, the plate members 62 and 63 being mounted to a rotating shaft 61 in parallel. The base mount assembly further comprises bearing-containing front linear rail guides 43 and bearing-containing rear linear rail guides 42 mounted onto the brace member 41, onto the front and rear plate members 63 and 62, respectively, and/or onto bearing carrier blocks. The rail support assembly comprises a mounting plate member and a depending plate member 53, the mounting plate member being disposed outwardly of the depending plate member 53, which extends inwardly toward the shaft 61. The mounting plate member is adapted to be joined to the base block assembly. The depending plate member 53 is preferably provided with front bearing mounts, channels or receptacles and rear bearing mounts, channels or receptacles, or other mechanical constructs suitable for retaining the linear bearings rails 56, and linear bearing rails 56 are connected to the front and rear bearing mounts. The rail support assembly is received within the base mount assembly by positioning the depending plate member 53 between the rail guides 42 and 43 such that the linear bearing rails 56 are received within the rail guides 42 and 43. With this structure the rail support assembly and the base block assembly are able to move radially inwardly and outwardly within the base mount assembly.

The improvement comprises the provision of a rear cam follower and a front cam follower mounted to the mandrel support assembly, wherein the rear cam follower is received within a rear cam and the front cam follower is received within a front cam, both of the cams being generally annular with the cam pathway defining and controlling the radial movement of the mandrel support assembly. The guidance tracks of the rear and front cam are coordinated and matched, with both cams being fixed. As shown in the drawings, the front cam may be fixed and supported with a front cam support member.

In this manner, as the mandrel support assemblies rotate about the shaft 61, the matched front and rear cams determine the radial position of the mandrels, extending them when necessary for contact with the printing blankets, for example, and retracting them when no contact is required. The unevenly distributed stresses and forces encountered when the mandrels are in the extended position and in contact with the printing blankets are now reduced since both the front and rear of the mandrel support assembly are supported by the cams.

Having thus described my invention, I claim:

1. A can decorator assembly comprising:
a base mount assembly having a base member mounted to a rotating plate member;
said rotating plat e member being mounted to a rotating shaft;
said base mount assembly further having front linear rail guides and bearing-containing rear linear guides located on a brace member proximate to the rotating plate member;
a rail support assembly having a mounting plate member and a depending plate member;
said mounting plate member being disposed outwardly of the depending plate member and depending plate member extending inwardly toward the rotating shaft; and
said mounting plate member being adapted to be joined to a base lock assembly.

2. The can decorator assembly of claim 1 wherein:
the brace member is mounted between a front plate member and a rear plate member.

3. The can decorator assembly of claim 1 wherein:
the depending plate is provided with front bearing mounts for retaining linear bearing rails.

4. The can decorator assembly of claim 1 wherein:
the depending plate is provided with channels for retaining linear bearing rails.

5. The can decorator assembly of claim 1 wherein:
the depending plate is provided with receptacles for retaining linear bearing rails.

6. The can decorator assembly of claim 1 wherein:
the rail support assembly is received within the base mount assembly by positioning the depending plate member between rail guides and such that the linear bearing rails are received within the rail guides.

7. A can decorator assembly comprising:
a base mount assembly having a base member mounted to a rotating plate member;
said rotating plat e member being mounted to a rotating shaft;
said base mount assembly further having front linear rail guides and bearing-containing rear linear guides located on a brace member proximate to the rotating plate member;
a rail support assembly having a mounting plate member and a depending plate member;
said mounting plate member being disposed outwardly of the depending plate member and depending plate member extending inwardly toward the rotating shaft;
said mounting plate member being adapted to be joined to a base lock assembly; and
the brace member is mounted between a front plate member and a rear plate member.

8. The can decorator assembly of claim 7 wherein:
the depending plate is provided with front bearing mounts for retaining linear bearing rails.

9. The can decorator assembly of claim 7 wherein:
the depending plate is provided with channels for retaining linear bearing rails.

10. The can decorator assembly of claim 7 wherein:
the depending plate is provided with receptacles for retaining linear bearing rails.

11. The can decorator assembly of claim 7 wherein:
the rail support assembly is received within the base mount assembly by positioning the depending plate member between rail guides and such that the linear bearing rails are received within the rail guides.

12. A can decorator assembly comprising:
a base mount assembly having a base member mounted to a rotating plate member;
said rotating plat e member being mounted to a rotating shaft;
said base mount assembly further having front linear rail guides and bearing-containing rear linear guides located on a brace member proximate to the rotating plate member;
a rail support assembly having a mounting plate member and a depending plate member;
said mounting plate member being disposed outwardly of the depending plate member and depending plate member extending inwardly toward the rotating shaft;
said mounting plate member being adapted to be joined to a base lock assembly; and
the rail support assembly is received within the base mount assembly by positioning the depending plate member between rail guides and such that the linear bearing rails are received within the rail guides.

13. The can decorator assembly of claim 7 wherein:
the brace member is mounted between a front plate member and a rear plate member.

14. The can decorator assembly of claim 7 wherein:
the depending plate is provided with front bearing mounts for retaining linear bearing rails.

15. The can decorator assembly of claim 7 wherein:
the depending plate is provided with channels for retaining linear bearing rails.

16. The can decorator assembly of claim 7 wherein:
the depending plate is provided with receptacles for retaining linear bearing rails.
